(19) United States
(12) Patent Application Publication
(10) Pub. No.: US 2025/0294427 A1
(43) Pub. Date: Sep. 18, 2025

(54) MESH-GATEWAY NETWORK AND METHOD

(71) Applicant: DRYAD NETWORKS GMBH, Eberswalde (DE)

(72) Inventors: Carsten BRINKSCHULTE, Berlin (DE); Marco BÖNIG, Dortmund (DE)

(73) Assignee: DRYAD NETWORKS GMBH, Eberswalde (DE)

(21) Appl. No.: 18/862,535

(22) PCT Filed: May 2, 2023
(86) PCT No.: PCT/EP2023/061571

§ 371 Date: Nov. 3, 2024

(30) Foreign Application Priority Data
May 3, 2022 (DE) 10 2022 110 794.9

(51) Int. Cl. H04W 40/22; G08B 17/00; G08B 25/10; H04W 84/18

(52) U.S. Cl. CPC H04W 40/22; G08B 17/005; G08B 25/10; H04W 84/18

(57) ABSTRACT

The invention relates to a forest fire early detection system comprising a mesh gateway network having a network server, multiple first gateways, and multiple terminals, wherein the shortest communication connection between a terminal and the network server of the mesh gateway network is a multi-hop connection and wherein the multi-hop connection has two or more hops between similar elements, as well as a corresponding method for communication in a mesh network.

The invention relates to a forest fire early detection system comprising a mesh gateway network having a network server, multiple first gateways, and multiple terminals, wherein the shortest communication connection between a terminal and the network server of the mesh gateway network is a multi-hop connection and wherein the multi-hop connection has two or more hops between similar elements, as well as a corresponding method for communication in a mesh network.

### PRIOR ART

Systems for early detection of forest fires are known. For this purpose, the area to be monitored is monitored by means of optical sensors that can detect columns of smoke arising during a forest fire. These sensors are, for example, rotatable cameras, but they have the disadvantage that they are less effective at night and are susceptible to false detections, for example, in the case of dust clouds resulting from agricultural activities. In addition, optical systems can usually only detect the forest fire when the forest fire is already advanced and the smoke columns become visible over greater distances. Monitoring by means of an IR camera installed in a satellite from a high orbit has the disadvantage that the resolution of the cameras over the long distances prevents detection of forest fires in the early stages. A satellite is also expensive to purchase and maintain, in particular when launching the satellite. Monitoring by mini-satellites in a low orbit has the disadvantage that the satellites are not geostationary, so they require a certain amount of time to complete one orbit, during which the area is not monitored. Close-meshed monitoring requires a large number of satellites, the launch of which is also costly. Satellite monitoring also involves high carbon dioxide emissions during launch.

It makes more sense to monitor the area by means of a plurality of inexpensive, mass-producible sensors that work by means of optical smoke detection and/or gas detection. The sensors are distributed throughout the area and deliver data to a base station via radio connection.

Such a system for early detection of forest fires is presented in the document US 2008/0309502 A1. In the event of a fire alarm, a sensor delivers information to a nearby control terminal, which then triggers an alarm by means of a long-range radio frequency signal.

This system has the disadvantage that the control terminal triggers the alarm and has to have a powerful RF unit for this purpose. The sensors require a GPS unit that constantly sends a signal to the control terminal; the power consumption of the sensors is therefore high, and the service life of the energy sources (batteries) of the sensors is limited.

It is therefore the object of the invention to provide a forest fire early detection system that works reliably, is expandable as desired, and is inexpensive to install and maintain, as well as enabling detection and prediction of the spreading direction and spreading speed of a forest fire. It is also the object of the present invention to provide a method for communication in a mesh network that works reliably, is expandable as desired, and is inexpensive to install and maintain.

The object is achieved by means of a forest fire early detection system having a mesh gateway network. Advantageous embodiments are set out in the dependent claims.

The forest fire early detection system according to the invention having a mesh gateway network has a network server. The network server has interfaces to other applications that can be used to analyze a forest fire, e.g. determining the extent, spreading direction, and spreading speed of a forest fire.

The forest fire early detection system according to the invention also has a plurality of first gateways. The first gateway communicates directly exclusively with other gateways, relays, and/or optionally also with terminals of the mesh gateway network.

The forest fire early detection system according to the invention also has a plurality of relays and terminals. The terminal has a sensor device which has one or a plurality of sensors for forest fire early detection, for example, for gas analysis. The relay controls the communication between the terminal and the gateway.

According to the invention, the shortest communication connection between a terminal and the network server of the mesh gateway network is a multi-hop connection, wherein the multi-hop connection has one or more hops between similar elements. Preferably, the shortest connection between a terminal of the forest fire early detection system according to the invention and a network server is a multi-hop connection comprising at least 3 hops.

In the scope of this document, terminals are elements similar to one another, and in the same way, first gateways are elements similar to one another. Terminals and first gateways are therefore elements dissimilar or different from one another. Furthermore, relays are also elements similar to one another, but relays and first gateways and/or relays and terminals are dissimilar or different elements.

The mesh gateway network therefore has terminals and first gateways that do not have a direct single-hop connection to a network server. Communication between the gateways occurs via a multi-hop connection. The shortest communication connection between a terminal and the network server therefore has at least two hops between terminals among one another and between two first gateways among one another.

A relay in the sense of this invention is a device that has a microcontroller, a radio, an antenna, and a power supply. A relay can transmit signals and/or messages between a terminal or a relay and another relay, a gateway, and/or a network server in both directions (uplink and downlink). The relay is a hardware device for forwarding messages from a terminal to the network and/or vice versa.

To save energy and to manage with a smaller power supply, the relay provides a wake-up function that allows the relay to be woken up from a standby and/or sleep mode. If a relay receives a wake-up signal, the wake-up signal is answered with a response signal to the sender of the wake-up signal. The sender of the wake-up signal (a terminal, another relay, or a gateway) now knows that the relay is ready to receive and can send the signal or message to the relay. After receiving this actual signal from the terminal, relay, or gateway and forwarding it to another relay, terminal, or gateway, the relay goes back into standby and/or sleep mode.

In a further development of the invention, the multi-hop connection has two or more hops between similar elements. For example, in a LoRaWAN network, communication between similar elements is not provided and thus the range is restricted. Multihop communication across multiple similar elements eliminates this restriction.

In a further embodiment of the invention, the multi-hop connection has one or more hops between two relays (R). The relays can be controlled in such a way that they do not have to be in receive mode at all times, like the gateways, for example. As a result, they consume significantly less energy and require a smaller power supply, which saves costs.

In a further development of the invention, the mesh gateway network has multiple second gateways. The second gateways communicate with the network server via an Internet connection. The Internet connection is a wireless point-to-point connection, preferably by means of a standard Internet protocol.

In a further embodiment of the invention, the first and second gateways represent different elements from one another. In another optional embodiment, relays are different from both first gateways and second gateways. The mesh gateway network therefore has four elements different from one another: terminals, relays, first gateways, and second gateways.

In a further embodiment of the invention, the multi-hop connection comprises a connection via multiple terminals. A terminal is connected to other terminals as well as to the first gateways via a single-hop connection.

In a further embodiment of the invention, relays are terminals that have a repeater function and/or a relay function. This enables a multi-hop connection between terminals. A message generated and sent by one terminal is received by another terminal, amplified if necessary, and forwarded.

A repeater in the sense of this document is an electrical or optical signal amplifier or conditioner for increasing the range of a signal. The repeater is located some distance from the transmitter, receives its signals, and forwards them in processed form, by which a greater distance can be bridged. When using digital transmission methods, the signal can also be decoded by the repeater, which removes signal interference (such as noise or distortion of the pulse shape). The signal is then re-encoded, modulated, and retransmitted. Simple repeaters do not influence the transmitted information, but only process the electrical or optical signal. In contrast, more advanced digital repeaters can add an identifier to the signal, for example, which allows the signal path to be traced back when there are multiple possible paths.

In a further embodiment of the invention, the terminals form a terminal mesh network with one another. Due to the repeater function and/or a relay function of the terminals, messages generated by a terminal are forwarded between terminals by means of a multi-hop connection.

In a further development of the invention, the terminal mesh network is connected to the network server via multiple gateways. By means of a multi-hop connection between terminals, a message generated by one terminal is forwarded until the message is received by a gateway connected to the network server.

In a further advantageous embodiment of the invention, the connection from the terminal to the network server comprises fewer gateways than are connected to the terminal mesh network. The multi-hop connection between the terminal and the network server for sending messages from a terminal to the network server is chosen in such a way that it is the shortest connection, i.e. has a minimum of hops. This reduces data transfer to a minimum.

In a further development of the invention, the multi-hop connection comprises a connection via multiple first and/or second gateways. A gateway is connected to both first gateways and second gateways via a single-hop connection.

In a further embodiment of the invention, the gateways have a repeater function and/or a relay function. This achieves a multi-hop connection between gateways. A message received by one gateway is received by another gateway, amplified if necessary, and forwarded.

In a further embodiment of the invention, the first gateways and/or the second gateways form a gateway mesh network with one another. Due to the repeater function and/or a relay function of the gateways, messages received by a gateway are forwarded between gateways via a multi-hop connection.

In another embodiment of the invention, the mesh gateway network comprises an LPWAN. LPWAN describes a class of network protocols for connecting low-power devices such as battery-operated sensors to a network server. The protocol is designed in such a way that a long range and low energy consumption of the terminals can be achieved with low operating costs.

In a further development of the invention, the mesh gateway network is a the LoRaWAN mesh gateway network. LoRaWAN manages with a particularly low power consumption. The LoRaWAN networks implement a star-shaped architecture by means of first and second gateway message packets between the terminals and the central network server. The second gateways are connected to the network server, while the terminals communicate with a first gateway by radio via LoRa.

In another embodiment of the invention, the second gateway has a communication interface that provides an Internet connection to the network server. The Internet connection is a wireless point-to-point connection, preferably by means of a standard Internet protocol.

In another embodiment of the invention, the terminals, the relays, and/or the first gateways have a self-sufficient energy supply. To be able to install and operate the terminals and the first gateways connected thereto even in impassable and especially rural areas far from energy supplies, the terminals, the relays, and the first gateways are equipped with a self-sufficient energy supply. The energy supply can be provided, for example, by energy storage devices—also rechargeable ones.

In a further development of the invention, the self-sufficient energy supply has an energy storage device and/or an energy conversion device. In particular, energy supply by means of solar cells should be mentioned, in which energy conversion from light to electrical energy takes place. The electrical energy is usually stored in an energy storage device to ensure energy supply even in times of low solar radiation (for example at night).

In another embodiment of the invention, the terminals and the first gateways are operated off-grid. Due to the self-sufficient energy supply of terminals, relays, and first gateways, these devices are operable autonomously without a supply network. Therefore, terminals, relays, and first gateways can be distributed and networked, particularly in impassable areas that are unreachable using conventional wireless networks.

In another design of the invention, the first gateways of the mesh gateway network are front-end gateways and/or the second gateway is a border gateway. The division of the gateways into front-end gateways and border gateways significantly expands the range of the LoRaWAN network, wherein standard LoRaWAN-compatible terminals can still be used, which can be distributed and networked far into impassable areas that are unreachable using conventional wireless networks.

In another embodiment of the invention, the first gateway has a first front-end gateway communication interface for communication with a terminal and a second front-end gateway communication interface for communication with another first gateway and/or a second gateway. The first gateway is therefore suitable as a node to communicate both with a terminal via a single-hop connection (chirp frequency spread modulation or frequency modulation) and with a gateway via a single-hop or preferably multi-hop connection as a meshed multi-hop wireless network. Both connections use different protocols and therefore require different interfaces.

In another embodiment of the invention, each first gateway is suitable for point-to-point wireless communication with a plurality of terminals using single-hop LoRa or FSK radio using the LoRaWAN protocol. Therefore, complete compatibility with commercially available LoRa terminals is provided. The first gateway communicates with the terminal via standard LoRaWAN radio protocol or via standard LoRa radio connection. It therefore does not need to be modified to take advantage of the mesh network. The mesh architecture is, so to speak, “transparent” for the terminal.

In a further embodiment of the invention, at least individual first gateways do not have a direct IP connection. Mesh gateways consist of a combination of the first gateways and the second gateways. The mesh gateways communicate with one another by means of the multi-hop wireless network, and at least one mesh gateway is connected to the network server via the standard Internet protocol.

In another design of the invention, the second gateway is provided for communication with the network server by means of a standard IP connection and using the LoRaWAN protocol. At least one of the first gateways communicates directly with a second gateway. The second gateway sends the data from a terminal directly to the network server by means of an Internet protocol. This type of communication and the division of the gateways into two types of gateways significantly expands the LoRaWAN network, wherein LoRaWAN-compatible terminals can still be used, which can be distributed and networked far into impassable areas that are unreachable using conventional wireless networks. These terminals are any commercially available devices that do not have to be adapted to use the advantages of the mesh network.

In another embodiment of the invention, the second gateway has a first border gateway communication interface for communication with a network server and a second border gateway communication interface for communication with a first gateway. The second gateway is therefore suitable for communicating with another gateway via a single-hop or, preferably, multi-hop connection as a meshed multi-hop wireless network. The network server can be communicated with in a wireless or wired manner via a standard Internet connection. Both connections use different protocols and therefore require different interfaces.

The object is also achieved by means of the method for communication in a mesh network having a network server, multiple first gateways, and multiple terminals of a forest fire early detection system. Advantageous embodiments of the invention are set out in the dependent claims.

To carry out the method according to the invention for communication in a mesh network having a network server, multiple relays, a first gateway, and multiple terminals of a forest fire early detection system, a signal is sent from a terminal to a network server or from a network server to a terminal via a communication connection. According to the invention, communication takes place via a multi-hop connection with one or more hops between similar elements.

In the scope of this document, all terminals are elements similar to one another, and in the same way, all first gateways are elements similar to one another. All relays are also similar elements. In contrast, relays and terminals or first gateways and relays and first gateways are elements dissimilar from one another.

The mesh gateway network therefore has terminals and first gateways that do not have a direct single-hop connection to a network server. Communication between the gateways occurs via a multi-hop connection. The shortest communication connection between a terminal and the network server therefore has at least one hop between terminals among one another and a first gateway among one another.

In a further development of the invention, communication takes place via a multi-hop connection with two or more hops between similar elements. For example, in a LoRaWAN network, communication between similar elements is not provided and thus the range is restricted. Multihop communication across multiple similar elements eliminates this restriction.

In a further embodiment of the invention, the multi-hop connection takes place with one or more hops between two relays (R). The relays can be controlled in such a way that they do not have to be in receive mode at all times, like the gateways, for example. As a result, they consume significantly less energy and require a smaller power supply, which saves costs.

In a further development of the invention, the multi-hop connection with two or more hops between similar elements is the shortest connection between the terminal and the network server. Preferably, the shortest connection between a terminal of the forest fire early detection system according to the invention and a network server is a multi-hop connection comprising at least 4 hops. The multi-hop connection between the terminal and the network server for sending messages from a terminal to the network server is chosen such that it is the shortest connection, i.e. has a minimum of hops. This reduces data transfer to a minimum.

In a further embodiment of the invention, the mesh network has multiple second gateways and communication takes place via the first and second gateways. A gateway is connected to both first gateways and second gateways via a single-hop connection. The second gateways communicate with the network server via an Internet connection.

In a further embodiment of the invention, the relays, the first gateways, and the second gateways represent different elements from one another. The mesh gateway network therefore has three elements different from one another: terminals, first gateways, and second gateways.

In a further embodiment of the invention, communication takes place via a multi-hop connection, wherein the multi-hop connection comprises a connection via multiple terminals. A terminal is connected both to other terminals and to the first gateways via a single-hop connection.

In a further embodiment of the invention, the terminals execute a repeater function and/or a relay function. This enables a multi-hop connection between terminals. A message generated and sent by one terminal is received by another terminal, amplified if necessary, and forwarded.

In a further embodiment of the invention, communication takes place via a terminal mesh network, wherein the terminal mesh network is formed by interconnected terminals. Due to the repeater function and/or a relay function of the terminals, messages generated by a terminal are forwarded between terminals by means of a multi-hop connection.

In a further development of the invention, communication from the terminal mesh network with the network server takes place via multiple gateways. By means of a multi-hop connection between terminals, a message generated by a terminal is forwarded until the message is received by a gateway connected to the network server.

In a further embodiment of the invention, communication takes place via a connection to the network server that comprises fewer gateways than are connected to the terminal mesh network. The multi-hop connection between the terminal and the network server for sending messages from a terminal to the network server is chosen such that it is the shortest connection, i.e. has a minimum of hops. This reduces data transfer to a minimum.

In a further development of the invention, communication takes place via a multi-hop connection, wherein the multi-hop connection comprises a connection via multiple first and/or second gateways. A gateway is connected to both first gateways and second gateways via a single-hop connection.

In a further embodiment of the invention, the gateways have a repeater function and/or a relay function. This achieves a multi-hop connection between gateways. A message received by one gateway is received by another gateway, amplified if necessary, and forwarded.

In a further embodiment of the invention, the first gateways and/or the second gateways form a gateway mesh network with one another. Due to the repeater function and/or a relay function of the gateways, messages received by a gateway are forwarded between gateways via a multi-hop connection.

In another embodiment of the invention, the mesh gateway network of the forest fire early detection system comprises an LPWAN. LPWAN describes a class of network protocols for connecting low-power devices such as battery-operated sensors to a network server. The protocol is designed in such a way that a long range and low energy consumption of the terminals can be achieved with low operating costs.

In a further development of the invention, the mesh gateway network comprises a LoRaWAN mesh gateway network. LoRaWAN manages with a particularly low power consumption. The LoRaWAN networks implement a star-shaped architecture by means of first and second gateway message packets between the terminals and the central network server. The second gateways are connected to the network server, while the terminals communicate with a first gateway by radio via LoRa.

In a further embodiment of the invention, the message is sent from the terminal to the first gateway via a multi-hop connection. By means of a multi-hop connection between terminals, a message generated by a terminal is forwarded until the message is received by a gateway connected to the network server.

In a further development of the invention, a terminal forwards the message to a second terminal. By means of a multi-hop connection between terminals, a message generated by a terminal is forwarded until the message is received by a gateway connected to the network server.

In a further embodiment of the invention, forwarding from terminal to terminal takes place via a multi-hop connection. By means of a multi-hop connection between terminals, a message generated by a terminal is forwarded until the message is received by a gateway connected to the network server. In particular, the multi-hop connection comprises at least 2 hops.

In another embodiment of the invention, the first gateway forwards the message to a second gateway and/or to the network server. A message received by one gateway is received by another gateway, amplified if necessary, and forwarded. The multi-hop connection has at least 2 hops between two gateways.

Exemplary embodiments of the forest fire early detection system according to the invention and the method according to the invention for communication in a mesh network are shown schematically in simplified form in the drawings and are explained in more detail in the following description.

In the figures:

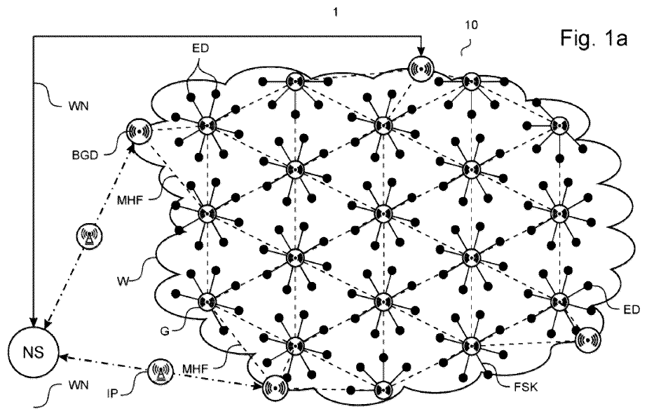

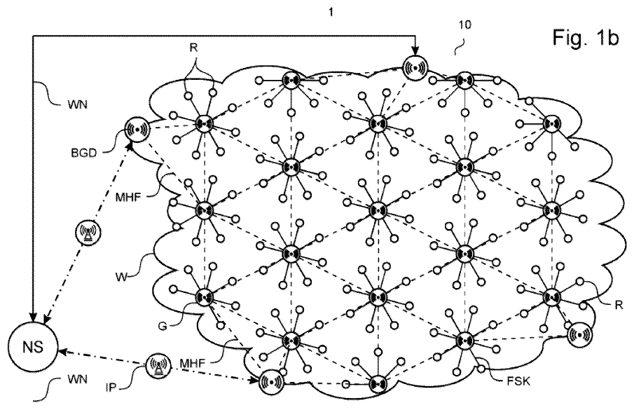

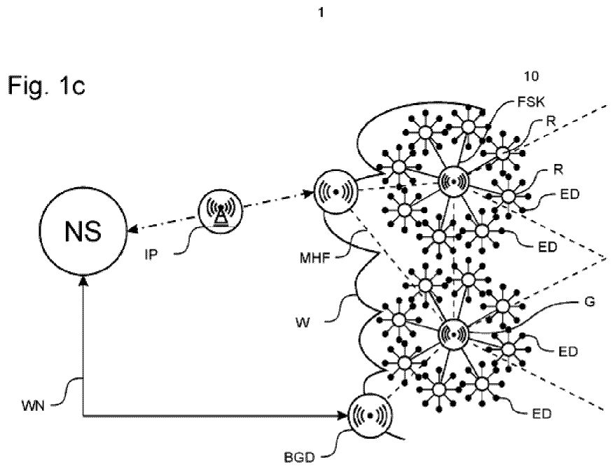

FIG. 1a shows a forest fire early detection system with a LoRaWAN mesh gateway network having terminals, a network server, and first and second gateways

FIG. 1b shows a forest fire early detection system with a LoRaWAN mesh gateway network having terminals, relays, a network server, and first and second gateways FIG. 1c shows a detailed view of a forest fire early detection system with a LoRaWAN mesh gateway network having terminals, relays, a network server, and first and second gateways

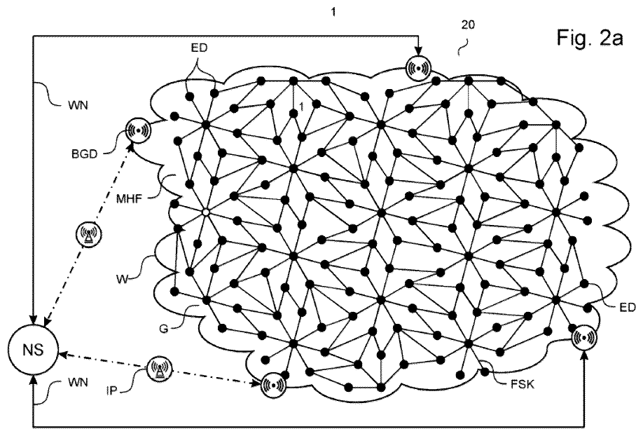

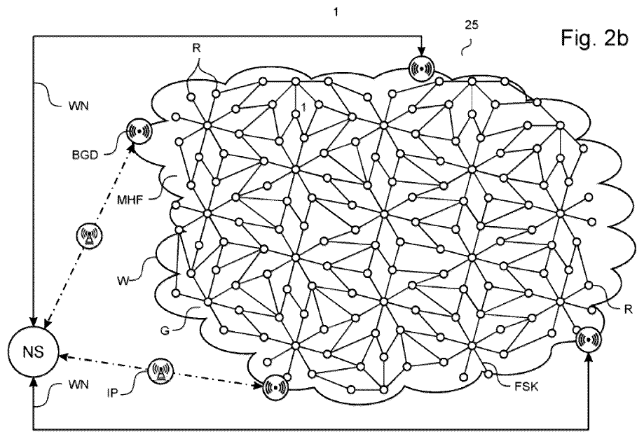

FIG. 2a shows a forest fire early detection system with a terminal mesh network having terminals, a network server, and border gateways

FIG. 2b shows a forest fire early detection system with a terminal mesh network having terminals, relays, a network server, and border gateways

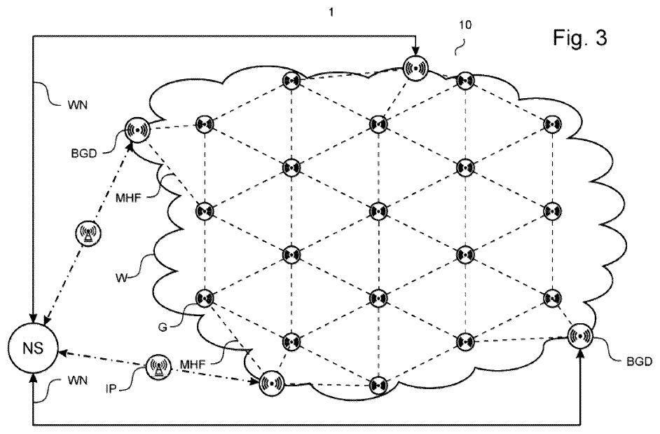

FIG. 3 shows a forest fire early detection system with a gateway mesh network having a network server and first gateways and border gateways

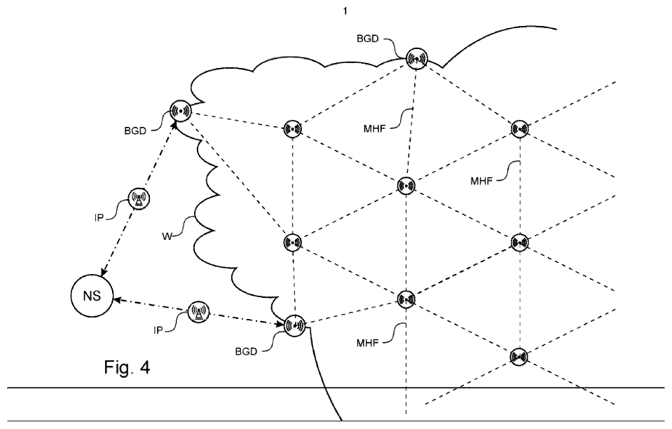

FIG. 4 shows a detailed view of a forest fire early detection system with a gateway mesh network having a network server and front-end and border gateways

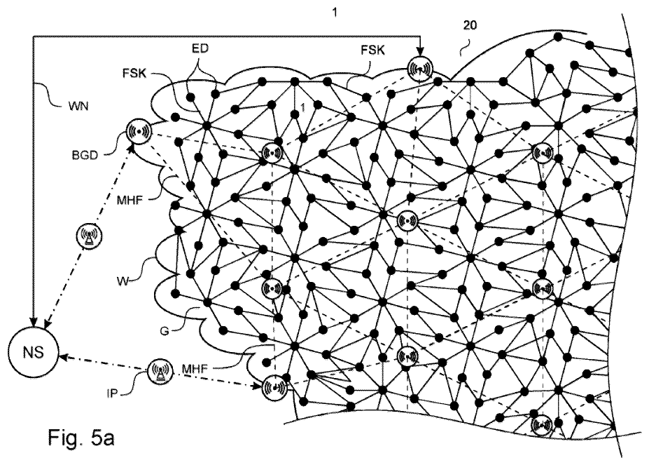

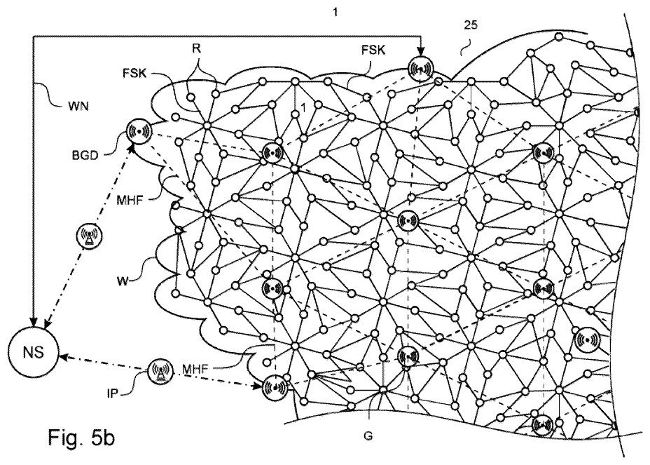

FIG. 5a shows a forest fire early detection system with a terminal mesh network and a gateway mesh network

FIG. 5b shows a forest fire early detection system with relays, a terminal mesh network, and a gateway mesh network

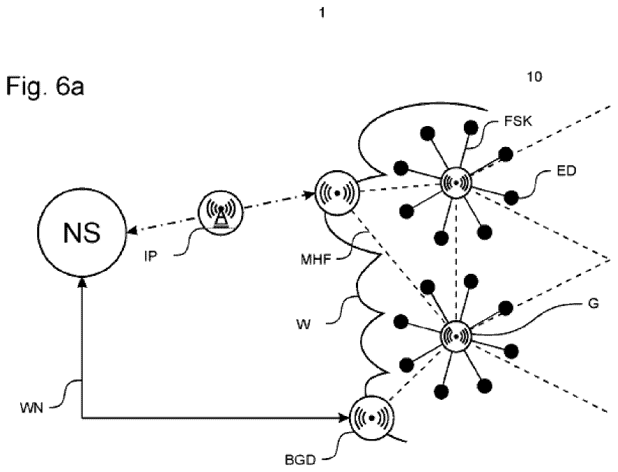

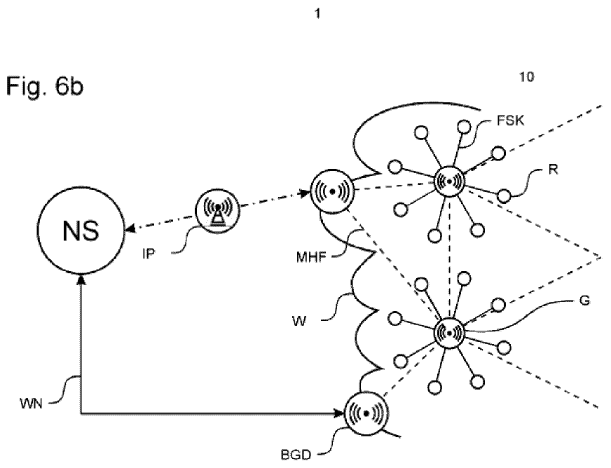

FIG. 6a shows a detailed view of a forest fire early detection system with a LoRaWAN mesh gateway network having terminals, a network server, and first and second gateways

FIG. 6b shows a detailed view of a forest fire early detection system with a LoRaWAN mesh gateway network having terminals, relays, a network server, and first and second gateways

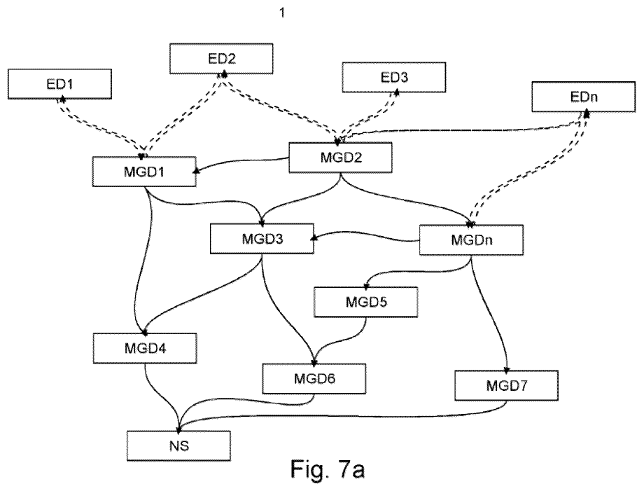

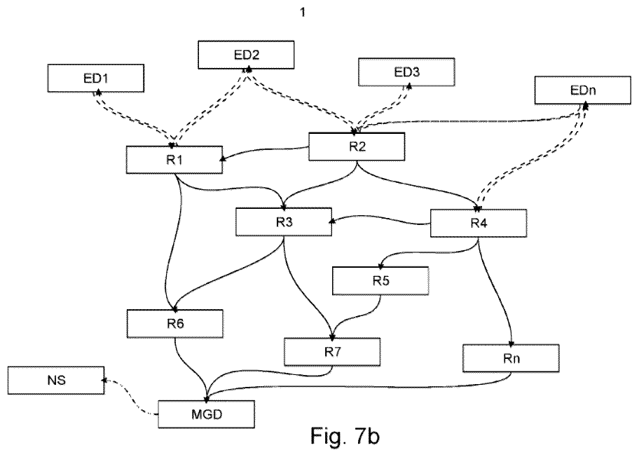

FIG. 7a shows connections in a standard LoRa wireless network

FIG. 7b shows connections in a standard LoRa wireless network with relays

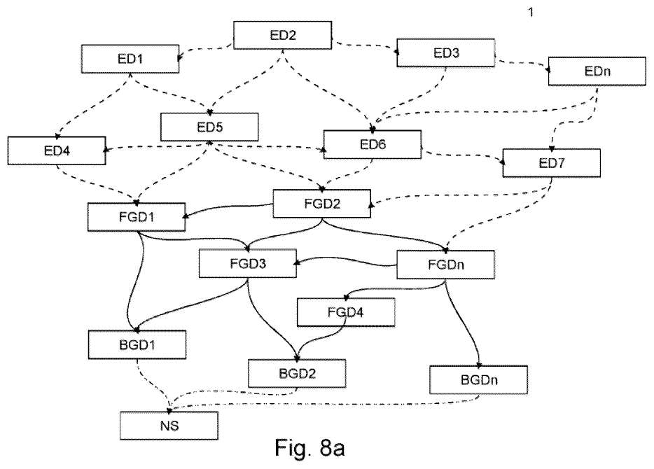

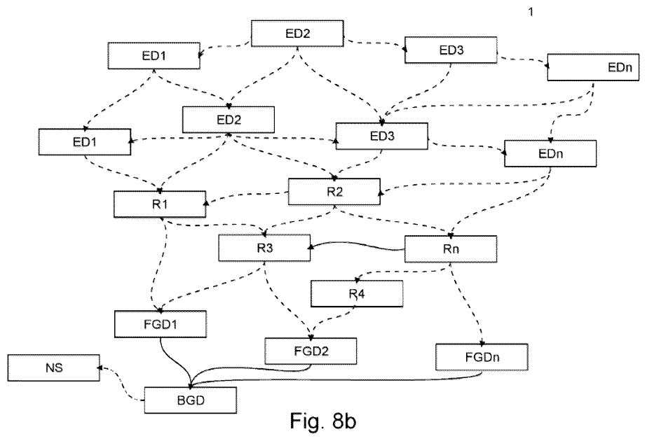

FIG. 8a shows connections in the LoRaWAN network, comprising a terminal mesh network and a gateway mesh network

FIG. 8b shows connections in the LoRaWAN network, comprising relays, a terminal mesh network, and a gateway mesh network

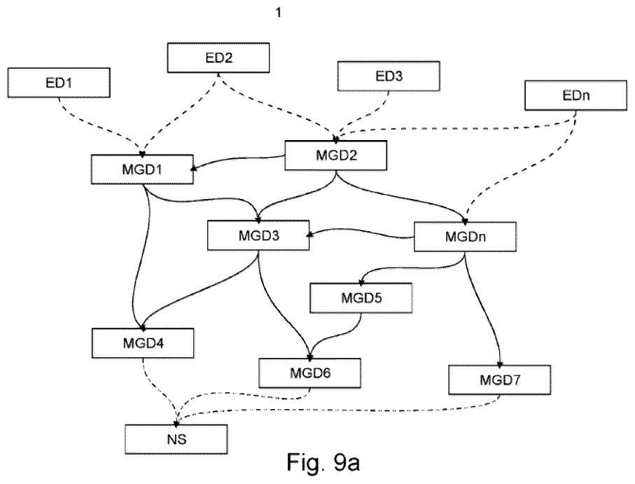

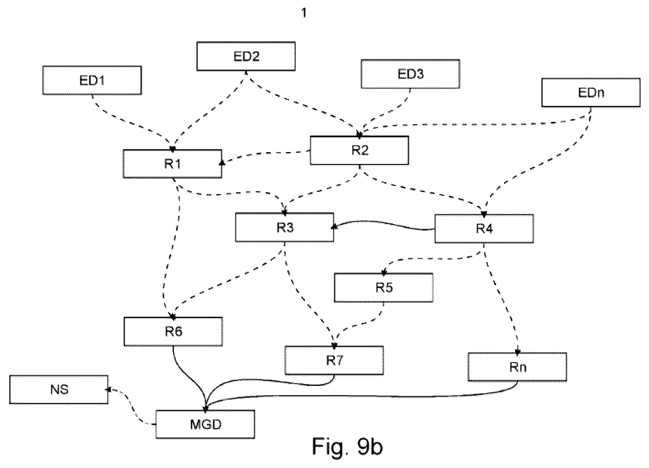

FIG. 9a shows connections in the LoRaWAN network according to the invention

FIG. 9b shows connections in the LoRaWAN network according to the invention having relays

FIG. 1a shows a forest fire early detection system 1 according to the invention arranged in the forest W to be monitored. The forest fire early detection system 1 has a plurality of terminals ED. A single terminal ED has a sensor unit for detecting a forest fire, which has sensors for determining ambient humidity, air pressure, and a temperature sensor, for example. Optionally or additionally, a terminal ED has sensors for gas analysis and for detecting the prevailing wind direction, which are used to determine the composition and concentration of gases as well as their spreading direction.

To be able to install and operate the terminal ED even in impassable and especially rural areas far away from energy supplies, a terminal ED is equipped with a self-sufficient energy supply E. In the simplest case, the energy supply is a battery, which can also be designed to be rechargeable. However, the use of capacitors, such as supercapacitors, is also possible. The use of solar cells is somewhat more complex and cost-intensive, but offers a very long service life for the terminal ED.

The terminal ED also has a communication interface as well as a first control device and an evaluation device. The communication interface of the terminal ED is wirelessly connected to the communication interfaces of the gateways Gn. The first control device is connected to the communication interface and the sensor device and controls them.

The forest fire early detection system 10 has a mesh gateway network 1 that uses the technology of a LoRaWAN network. The LoRaWAN network has a star-shaped architecture in which message packets are exchanged between the sensors ED and a central Internet network server NS by means of gateways. The forest fire early detection system 10 has a large number of terminals ED, which are connected to gateways G1, G2 via a single-hop connection FSK. The first gateways G1 are usually front-end gateways FGD. The front-end gateways FGD are connected to one another and partly to border gateways BGD. The border gateways BGD are connected to the Internet network server NS, either via a wired connection WN or via a wireless connection by means of the Internet protocol IP.

The front-end gateways FGD and the border gateways BGD are connected to one another via a multi-hop mesh network MHF, so that a front-end gateway FGD does not require a direct connection to the Internet network server NS. This achieves a range extension of the LoRaWAN networks by interposing a multi-hop network by means of front-end gateways FGD and thus achieves complete compatibility with the LoRaWAN specification.

FIG. 1b shows a forest fire early detection system 1 according to the invention arranged in the forest W to be monitored. The forest fire early detection system 1 has a plurality of relays R. A single relay R has a communication device for receiving and sending signals, data, and messages. Optionally, a relay R can be equipped with terminal functionality to detect a forest fire via a sensor unit that has sensors, for example, for determining ambient humidity, air pressure, and a temperature sensor. Optionally or additionally, a relay R with terminal functionality has sensors for gas analysis and for detecting the prevailing wind direction, which are used to determine the composition and concentration of gases as well as their spreading direction. The relay also has a first control device and an evaluation device. The first control device is connected to the communication interface and the sensor device and controls them.

To be able to install and operate the relay R even in impassable and especially rural areas far away from energy supplies, a relay R is equipped with a self-sufficient energy supply E. In the simplest case, the energy supply is a battery, which can also be designed to be rechargeable. However, the use of capacitors, such as supercapacitors, is also possible. The use of solar cells is somewhat more complex and cost-intensive, but offers a very long service life of the relay R.

The relay also has a communication interface and a first control device. The communication interface of the relay R is wirelessly connected to the communication interfaces of other relays R, terminals ED, and/or the gateways Gn.

The forest fire early detection system 10 has a mesh gateway network 1 that uses the technology of a LoRaWAN network. The LoRaWAN network has a star-shaped architecture in which message packets are exchanged between the sensors of the terminals ED and a central Internet network server NS by means of relays R and/or gateways Gn. The forest fire early detection system 10 then has a large number of terminals ED, which are connected to relays R and/or gateways G1, G2 via a single-hop connection FSK. The relays R are connected to other terminals ED, other relays R, and/or gateways Gn via single-hop connections. The relays R are also connected to other relays R via multi-hop connections. The first gateways G1 are usually front-end gateways FGD. The front-end gateways FGD are connected to one another and partly to border gateways BGD. The border gateways BGD are connected to the Internet network server NS, either via a wired connection WN or via a wireless connection by means of the Internet protocol IP.

The front-end gateways FGD and the border gateways BGD are connected to one another via a multi-hop mesh network MHF, so that a front-end gateway FGD does not require a direct connection to the Internet network server NS. This achieves a range extension of the LoRaWAN networks by interposing a multi-hop network by means of front-end gateways FGD and thus achieves complete compatibility with the LoRaWAN specification.

A detailed view of the forest fire early detection system 10 according to the invention arranged in the forest W to be monitored is shown in FIG. 1c. The forest fire early detection system 10 has a plurality of terminals ED equipped with sensors, wherein eight terminals ED each communicate with a relay via a single-hop connection FSK. The relays R in turn also communicate with a gateway G1 via a single-hop connection. The relays R can also communicate with one another via single-hop and/or multi-hop connections, however. The gateways G1 are front-end gateways FGD. The front-end gateways FGD are connected to one another and to border gateways BGD. The border gateways BGD are connected to the Internet network server NS, specifically via a wired connection WN or via a wireless connection by means of the Internet protocol IP.

An exemplary embodiment of a terminal mesh network 20 is shown in FIG. 2a. The terminal mesh network 20 has a plurality of terminals ED distributed over the forest W to be monitored as well as four border gateways BGD. The terminal mesh network 20 is connected via the four border gateways BGD to the network server NS, wherein the border gateways BGD are directly connected to the Internet network server NS, either via a wired connection WN or via a wireless connection by means of the Internet protocol IP.

A terminal ED is connected to at least one other terminal ED by means of a single-hop connection FSK. A terminal ED has a communication interface for this purpose. By means of the communication interface, messages from the terminal ED, in particular measurement data, are sent as a data packet wirelessly to at least one other terminal ED by means of a single-hop connection FSK via LoRa (chirp frequency spread modulation) or frequency modulation.

The communication connection from a terminal ED to the Internet network server NS runs via a multi-hop connection between the terminal ED, which generates a signal for forwarding to the Internet network server NS, and further terminals ED, until a terminal ED sends the generated signal to a border gateway BGD, it is received by the border gateway BGD and sent to the Internet network server NS. The connection between the terminal ED and the border gateway BGD is also wireless by means of a single-hop connection FSK via LoRa (chirp frequency spread modulation) or frequency modulation. The multi-hop connection is such that at least two hops are performed between two terminals ED.

In this exemplary embodiment, the connection of a terminal ED to the network server NS is established via exactly one border gateway BGD and therefore comprises fewer gateways BGD than are connected to the terminal mesh network 20. The multi-hop connection of a terminal ED to the network server NS with two or more hops between the terminals ED is advantageously chosen such that it is the shortest multi-hop connection between the terminal ED and the network server NS, in other words the minimum number of terminals ED between the terminal ED, which generates a signal for forwarding to the Internet network server NS, and a border gateway BGD for connection is used.

The terminals ED have a repeater function for wired connections and/or a relay function for radio connections. The signal received on the terminal ED is forwarded and amplified if necessary. This enables the signals generated by an terminal ED to be transmitted over longer distances than would be possible with a direct connection. Topographical obstacles in the forest W to be monitored are also avoided.

An exemplary embodiment of a relay mesh network 25 is shown in FIG. 2b. The relay mesh network 25 has a plurality of terminals ED (not shown in FIG. 2b) distributed over the forest W to be monitored, a plurality of relays R which together form a mesh network, and four border gateways BGD. The relay mesh network 25 is connected via the four border gateways BGD to the network server NS, wherein the border gateways BGD are directly connected to the Internet network server NS, either via a wired connection WN or via a wireless connection by means of the Internet protocol IP.

A relay R is connected to at least one other relay R and one or more terminals ED by means of a single-hop connection FSK. A relay R has a communication interface for this purpose. By means of the communication interface, messages from the terminal ED, in particular measurement data, received by a terminal ED or a relay R are forwarded as a data packet wirelessly to at least one other relay R by means of a single-hop connection FSK via LoRa (chirp frequency spread modulation) or frequency modulation.

The communication connection from a terminal ED to the Internet network server NS runs via a multi-hop connection between the relay R, which generates a signal for forwarding to the Internet network server NS, and one or more other relays R, until a relay R sends the generated signal to a border gateway BGD, it is received by the border gateway BGD and sent to the Internet network server NS. The connection between the relay R and the border gateway BGD is also wireless by means of a single-hop connection FSK via LoRa (chirp frequency spread modulation) or frequency modulation. The multi-hop connection is such that at least two hops are performed between two relays R.

In this exemplary embodiment, the connection of a relay R to the network server NS is established via exactly one border gateway BGD and therefore comprises fewer gateways BGD than are connected to the relay mesh network 25. The multi-hop connection of a relay R to the network server NS with two or more hops between the relays R is advantageously chosen such that it is the shortest multi-hop connection between the relay R and the network server NS, in other words the minimum number of relay R between the terminal ED, which generates a signal for forwarding to the Internet network server NS, and a border gateway BGD for connection is used.

The relays R have a repeater function and/or a relay function for radio connections for this purpose. The signal received on the relay R is forwarded and amplified if necessary. In an optional embodiment, the signal is sent to a predetermined or selected receiver R, BGD. This receiver can be a relay R and/or a gateway (front-end and/or border gateway BGD) (not shown in FIG. 2b). This enables the signals generated by a relay R to be transmitted over longer distances than would be possible with a direct connection. Topographical obstacles in the forest W to be monitored are also avoided.

FIG. 3 shows an exemplary embodiment of a gateway mesh network 30. The gateway mesh network 30 has a plurality of first gateways G1 distributed over the forest W to be monitored as well as four border gateways BGD. The gateways G1 are front-end gateways FGD. The gateway mesh network 30 is connected via the four border gateways BGD to the network server NS, wherein the border gateways BGD are directly connected to the Internet network server NS, either via a wired connection WN or via a wireless connection by means of the Internet protocol IP.

A first gateway G1 is directly connected to the directly adjacent first gateways G1 by means of a single-hop connection MHD. Eight first G1 gateways are also directly connected to one of the four border gateways BGD.

In this exemplary embodiment, the connection of a first gateway G1 to the network server NS is established via exactly one border gateway BGD and comprises, as in the previous exemplary embodiment (see FIG. 3) fewer gateways BGD than are connected to the gateway mesh network 30. The multi-hop connection of a first gateway G1 to the network server NS with two or more hops between the first gateways G1 is also chosen such that it is the shortest multi-hop connection between a first gateway G1 and the network server NS. The first gateways G1 also have a repeater function for wired connections and/or a relay function for radio connections.

FIG. 4 shows a detailed view of an exemplary embodiment of a gateway mesh network 30. The gateway mesh network 30 has a plurality of first gateways G1 distributed over the forest W to be monitored as well as two border gateways BGD. The gateway mesh network 30 is connected via the two border gateways BGD to the network server NS, wherein the border gateways BGD are directly connected to the Internet network server NS via a wireless connection by means of the Internet protocol IP.

FIG. 5a shows an embodiment of a forest fire early detection system 1 according to the invention arranged in the forest W to be monitored. The forest fire early detection system 1 has a terminal mesh network 20 (see FIG. 2) and a gateway mesh network 30 (see FIG. 3), which together form the mesh gateway network 1. The front-end gateways FGD and the border gateways BGD are connected to one another via a multi-hop mesh network MHF, so that a front-end gateway FGD does not have a direct connection to the Internet network server NS.

A terminal ED is connected to at least one other terminal ED by means of a single-hop connection FSK. Messages, such as measurement data, are forwarded from the terminal ED as a data packet wirelessly by means of a single-hop connection FSK via LoRa (chirp frequency spread modulation) or frequency modulation to at least one other terminal ED.

The communication connection from a terminal ED to the Internet network server NS runs via a multi-hop connection between the terminal ED, which generates a signal for forwarding to the Internet network server NS, sends it to a front-end gateway FGD, and receives it from the front-end gateway FGD. The signal is then sent to one or other front-end gateways FGD, received by them and forwarded to a border gateway BGD, from which the signal is forwarded to the Internet network server NS.

For this purpose, a first gateway G1 has a first front-end gateway communication interface. Messages from the terminal ED are received and forwarded by means of the first front-end gateway communication interface. A first gateway G1 also has a further second front-end gateway communication interface for communication with another first gateway G1 and/or a second gateway G2. A second gateway G2 also has a second border gateway communication interface for communication with a first gateway G1 and a first border gateway communication interface for communication with a network server. The first gateways G1 and second gateways G2, like the terminals ED, each have a self-sufficient power supply.

FIG. 5b shows an embodiment of a forest fire early detection system 1 according to the invention arranged in the forest W to be monitored. The forest fire early detection system 1 has a relay mesh network 25 (see FIG. 2b) and a gateway mesh network 30 (see FIG. 3), which together form the mesh gateway network 1. The front-end gateways FGD and the border gateways BGD are connected to one another via a multi-hop mesh network MHF, so that a front-end gateway FGD does not have a direct connection to the Internet network server NS.

A terminal ED (not shown in FIG. 5b) is connected to at least one relay R by means of a single-hop connection FSK. A relay R is connected to at least one other relay R via a single-hop connection FSK and to at least one other relay R via a multi-hop connection. Messages, e.g. measurement data from a terminal ED, are forwarded by the relay R as a data packet wirelessly to at least one other relay R by means of a single-hop connection and/or a multi-hop connection FSK via LoRa (chirp frequency spread modulation) or frequency modulation.

The communication connection from a terminal ED to the Internet network server NS runs via a multi-hop connection between the terminal ED, which generates a signal for forwarding to the Internet network server NS, sends it to a relay R, and receives it from the relay R. The signal is then sent to one or other relays, received by them and forwarded via a first gateway G1 to a border gateway BGD, from which the signal is forwarded to the Internet network server NS.

A relay R has a communication interface for this purpose. By means of the communication interface, messages from the terminal ED, in particular measurement data, received by a terminal ED or a relay R are forwarded as a data packet wirelessly to at least one other relay R by means of a single-hop connection FSK via LoRa (chirp frequency spread modulation) or frequency modulation. For this purpose, a first gateway G1 has a first front-end gateway communication interface. Messages from the terminal ED are received and forwarded by means of the first front-end gateway communication interface. A first gateway G1 also has a further second front-end gateway communication interface for communication with another first gateway G1 and/or a second gateway G2. A second gateway G2 also has a second border gateway communication interface for communication with a first gateway G1 and a first border gateway communication interface for communication with a network server. The first gateways G1 and second gateways G2, like the terminals ED, each have a self-sufficient power supply.

A detailed view of a forest fire early detection system 10 according to the invention, arranged in the forest W to be monitored, is shown in FIG. 6a. The forest fire early detection system 10 has a plurality of terminals ED equipped with sensors, wherein eight terminals ED each communicate with a gateway G1 via a single-hop connection FSK. The gateways G1 are front-end gateways FGD. The front-end gateways FGD are connected to one another and to border gateways BGD. The border gateways BGD are connected to the Internet network server NS, specifically via a wired connection WN or via a wireless connection by means of the Internet protocol IP.

A detailed view of a forest fire early detection system 10 according to the invention, arranged in the forest W to be monitored, is shown in FIG. 6b. The forest fire early detection system 10 has a plurality of terminals ED (not shown in FIG. 6b) equipped with sensors, which each communicate with at least one relay. Eight relays R each communicate with a gateway G1 via a single-hop connection FSK. The gateways G1 are front-end gateways FGD. The front-end gateways FGD are connected to one another and to border gateways BGD. The border gateways BGD are connected to the Internet network server NS, specifically via a wired connection WN or via a wireless connection by means of the Internet protocol IP.

FIG. 7a schematically shows an embodiment of the LoRaWAN network 1, into which the forest fire early detection system 10 according to the invention is integrated. In this exemplary embodiment, front-end gateways FGD and border gateways BGD are combined in one device.

These mesh gateways MGDn are a combination of the front-end gateways FGDn and the border gateways BGD. The mesh gateways MGDn communicate with one another by means of the multi-hop wireless network MHF and at least one mesh gateway MDG is connected via a cable connection WN to the network server NS via the standard Internet protocol IP.

The terminal EDn does not have to have a permanently active download-receive window and therefore does not need to be constantly active. The power consumption is reduced and the operating time of the terminals EDn is thus increased.

FIG. 7b schematically shows an embodiment of the LoRaWAN network 1, into which the forest fire early detection system 10 according to the invention is integrated. In this exemplary embodiment, front-end gateways FGD and border gateways BGD are combined in one device.

This mesh gateway MGD is a combination of the front-end gateways FGDn and the border gateways BGD. The mesh gateways MGDn communicate with one another by means of the multi-hop wireless network MHF and at least one mesh gateway MGD is connected via a cable connection WN to the network server NS via the standard Internet protocol IP.

The communication from a terminal ED1, ED2, ED3, EDn takes place here with the aid of multi-hop connections via multiple relays R1, R2, R3, R4, R5, R6, R7, Rn to the mesh gateway MDG and from the mesh gateway MGD to the network server NS. Optionally, the relays R1, R2, R3, R4, R5, R6, R7, Rn form a mesh relay network here. The terminal EDn does not have to have a permanently active download-receive window and therefore does not need to be constantly active. The power consumption is reduced and the operating time of the terminals EDn is thus increased.

FIG. 8a schematically shows another embodiment of the LoRaWAN network 1, into which the forest fire early detection system 10 according to the invention is integrated. The network 1 has a plurality of sensors ED, which are partly connected to one another and partly to front-end gateways FGD via a single-hop connection FSK. The front-end gateways FGD are connected to one another and partly to border gateways BGD. A border gateway BGD can also be combined with a front-end gateway FGD to form a mesh gateway device MDG in one device. The border gateways BGD are connected to the Internet network server NS via a wireless connection by means of the Internet protocol IP.

The front-end gateways FGD and the border gateways BGD are connected to one another via a multi-hop mesh network MHF, so that a front-end gateway FGD does not require a direct connection to the Internet network server NS. This achieves a range extension of the LoRaWAN networks by interposing a multi-hop network by means of front-end gateways FGD and thus achieving complete compatibility with the LoRaWAN specification.

FIG. 8b schematically shows another embodiment of the LoRaWAN network 1, into which the forest fire early detection system 10 according to the invention is integrated. The network 1 has a plurality of sensors installed in terminals ED, which communicate partly with one another and partly with relays R1, R2, R3, R4, Rn via a single-hop connection FSK. The relays R, R1, R2, R3, R4, Rn communicate partly with one another and partly with front-end gateways FGD. The front-end gateways FGD are connected to one another and partly to border gateways BGD. A border gateway BGD can also be combined with a front-end gateway FGD to form a mesh gateway device MDG in one device. The border gateways BGD are connected to the Internet network server NS via a wireless connection by means of the Internet protocol IP.

The front-end gateways FGD and the border gateways BGD are connected to one another via a multi-hop mesh network MHF, so that a front-end gateway FGD does not require a direct connection to the Internet network server NS. This achieves a range extension of the LoRaWAN networks by interposing a multi-hop network by means of front-end gateways FGD and thus achieving complete compatibility with the LoRaWAN specification.

FIG. 9a schematically shows another embodiment of the LoRaWAN network 1, into which the forest fire early detection system 10 according to the invention is integrated. Front-end gateways FGD and border gateways BGD are combined in one device. The mesh gateways MGDn consist of a combination of the front-end gateways FGDn and the border gateways BGDn. The mesh gateways MGDn communicate with one another by means of the multi-hop wireless network MHF and at least one mesh gateway MGD is connected to the network server NS via the standard Internet protocol IP.

FIG. 9b schematically shows another embodiment of the LoRaWAN network 1, into which the forest fire early detection system 10 according to the invention is integrated. Front-end gateways FGD and border gateways BGD are combined in one device. The relays R1, R2, R3, R4, R5, R6, R7 communicate with one another by means of the multi-hop wireless network MHF, and with at least one mesh gateway MGD, which is in turn connected to the network server NS via the standard Internet protocol IP.

### LIST OF REFERENCE SIGNS

1 mesh gateway network
10 forest fire early detection system
20 terminal network
25 relay mesh network
30 gateway network
ED, ED1, ED2, terminals/sensors
ED3, ED4, ED5,
ED6, ED7, EDn
G1 first gateway
G2 second gateway
NS Internet network server
IP Internet protocol
BGD, BGD1, border gateways
BGD2, BGDn
FGD, FGD1, front-end gateways
FGD2, FGD3,
FGD4, FGDn
MHF multi-hop wireless network
MGD, MGD1, mesh gateways
MGD2, MGD3,
MGD4, MGD5,
MGD6, MGD7,
MDGn
R, R1, R2, R3, R4, relay
R5, R6, R7, Rn
FSK connection by means of FSK modulation
WN wired connection
W forest

The invention claimed is:

1.-45. (canceled)

46. A forest fire early detection system (10) comprising a mesh gateway network (1) having
a network server (NS),
a first gateway (G1),
multiple relays (R)
multiple terminals (ED),
characterized in that
the shortest communication link between a terminal (ED) and the network server (NS) of the mesh gateway network (1) is a multi-hop connection,
wherein the multi-hop connection has one or more hops between similar elements (ED, G1, R).

47. The forest fire early detection system (10) of claim 46,
characterized in that
the multi-hop connection has two or more hops between similar elements (ED, G1, R).

48. The forest fire early detection system (10) of claim 46,
characterized in that
the multi-hop connection has one or more hops between two relays (R).

49. The forest fire early detection system (10) of claim 46,
characterized in that
the mesh gateway network (1) has multiple second gateways (G2),
whereas the relays (R), the first gateways (G1), and/or the second gateways (G2) represent different elements,
whereas the second gateway (G2) is provided for communication with the network server (NS) by means of a standard IP connection (IP) and using the LoRaWAN protocol,
whereas the second gateway (G2) has a first border gateway communication interface for communication with a network server (NS), and a second border gateway communication interface for communication with a first gateway (G1).

50. The forest fire early detection system (10) of claim 46,
characterized in that
the multi-hop connection comprises a connection via multiple terminals (ED),
whereas the relays (R) are terminals (ED) that have a repeater function and/or a relay function,
whereas the terminals (ED) form a terminal mesh network (20) with one another,
whereas the terminal mesh network (20) is connected to the network server (NS) via multiple gateways (G1, G2),
whereas the connection from the terminal to the network server (NS) comprises fewer gateways (G1, G2) than are connected to the terminal mesh network (20).

51. The forest fire early detection system (10) of claim 46,
characterized in that
the multi-hop connection comprises a connection via multiple first gateways (G1) and/or second gateways (G2),
whereas the gateways (G1, G2) have a repeater and/or a relay function.

52. The forest fire early detection system (10) of claim 46,
characterized in that
the first gateways (G1) and/or the second gateways (G2) together form a gateway mesh network (30).

53. The forest fire early detection system (10) of claim 46,
characterized in that
the mesh gateway network (1) comprises an LPWAN.

54. The forest fire early detection system (10) of claim 46,
characterized in that
the mesh gateway network (1) comprises a LoRaWAN.

55. The forest fire early detection system (10) of claim 46,
characterized in that
the second gateway (G2) has a communication interface that provides an Internet connection (IP) to the network server (NS).

56. The forest fire early detection system (10) of claim 46,
characterized in that
the terminals (ED), the relays (R), and/or the first gateways (G1) have a self-sufficient energy supply.

57. The forest fire early detection system (10) of claim 46,
characterized in that
the self-sufficient energy supply comprises an energy storage device and/or energy conversion device.

58. The forest fire early detection system (10) of claim 46,
characterized in that
the terminals (ED) and the first gateways (G1) are operated off-grid.

59. The forest fire early detection system of claim 46,
characterized in that
the first gateways (G1) of the mesh gateway network (1) are front-end gateways (FGD) and/or the second gateway (G2) is a border gateway (BGD).

60. The forest fire early detection system (10) of claim 46,
characterized in that
the first gateway (G1) has a first gateway communication interface for communication with a terminal (ED) and a second gateway communication interface for communication with another first gateway (G1) and/or a second gateway (G2).

61. The forest fire early detection system (10) of claim 46,
characterized in that
each first gateway (G1) is suitable for point-to-point wireless communication with a plurality of terminals (ED) using multi-hop (FSK) LoRa or FSK radio using the LoRaWAN protocol.

62. The forest fire early detection system (10) of claim 46,
characterized in that
at least individual first gateways (G1) do not have a direct IP connection (IP).

63. A method for communication in a mesh network (1) with a network server (NS), multiple relays (R), a first gateway (G1), and multiple terminals (ED) of a forest fire early detection system (10) comprising the following steps
sending a signal from a terminal (ED) to a network server (NS) or from a network server (NS) to a terminal (ED) via a communication link,
characterized in that
the communication takes place via a multi-hop connection with one or more hops between similar elements.

64. The method for communication in a mesh network (1) of claim 63,
characterized in that
the multi-hop connection with two or more hops between similar elements is the shortest connection between the terminal (ED) and the network server (NS).

65. The method for communication in a mesh network (1) of claim 63,
characterized in that
communication takes place via a multi-hop connection with two or more hops between similar elements.

66. The method for communication in a mesh network (1) of claim 63,
characterized in that
the multi-hop connection has one or more hops between two relays (R).

67. The method for communication in a mesh network (1) of claim 63,
characterized in that
the mesh network (1) has multiple second gateways (G2) and communication takes place via the first gateways (G1) and the second gateways (G2),
whereas the relays (R), the first gateways (G1), and/or the second gateways (G2) represent different elements.

68. The method for communication in a mesh network (1) of claim 63,
characterized in that
the communication takes place via a multi-hop connection, wherein the multi-hop connection comprises a connection via multiple terminals (ED),
whereas the terminals (ED) perform a repeater function and/or relay function,
whereas communication takes place via a terminal mesh network (20), wherein the terminal mesh network (20) is formed by interconnected terminals (ED),
whereas communication from the terminal mesh network (20) to the network server (NS) takes place via multiple gateways (G1, G2),
whereas communication takes place via a connection to the network server (NS) that comprises fewer gateways (G1, G2) than are connected to the terminal mesh network (20).

69. The method for communication in a mesh network (1) of claim 63,
characterized in that
the communication takes place via a multi-hop connection, wherein the multi-hop connection comprises a connection via multiple first gateways (G1) and/or second gateways (G2),
whereas the gateways (G1, G2) carry out a repeater and/or a relay function,
whereas the communication takes place via a gateway mesh network (30), wherein the first gateways (G1) and/or the second gateways (G2) form the gateway mesh network (30) with one another.

70. The method for communication in a mesh network (1) of claim 63,
characterized in that
the mesh gateway network (1) comprises an LPWAN.

71. The method for communication in a mesh network (1) of claim 63,
characterized in that
the mesh gateway network (1) comprises a LoRaWAN.

72. The method for communication in a mesh network (1) of claim 63,
characterized in that
the message is sent from the terminal (ED) to the first gateway (G1) via a multi-hop connection.

73. The method for communication in a mesh network (1) of claim 63,
characterized in that
a terminal (ED) forwards the message to a second terminal (ED),
whereas the forwarding from terminal (ED) to terminal (ED) occurs via a multi-hop connection.

74. The method for communication in a mesh network (1) of claim 63,
characterized in that
the first gateway (G1) forwards the message to a second gateway (G2) and/or the network server (NS).
